(19) United States
(12) Patent Application Publication
(10) Pub. No.: US 2010/0146481 A1
(43) Pub. Date: Jun. 10, 2010

(54) DEVELOPING APPLICATIONS AT RUNTIME

(75) Inventors: Joseph Stephen Binder, Seattle, WA (US); Douglas Jay Rosen, Woodinville, WA (US); Patrick M. Dengler, Redmond, WA (US); John Joseph Rivard, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/331,200

(22) Filed: Dec. 9, 2008

(51) Int. Cl. G06F 9/44

(52) U.S. Cl. 717/110

(57) ABSTRACT

Data applications may be developed within an integrated development environment comprising an iterative cycle of writing source code, building the source code, running the data application, and testing the data application. The development becomes iterative because the application is torn down, redesigned, rebuilt, and re-executed if the data application is modified. Developing an application at runtime is disclosed herein, which is generally more efficient than conventional iterative techniques. As provided herein, runtime application comprising prebuilt components is presented to a user. The runtime application may be modified through modification gestures. An update assembly may be built based upon the modification gestures. The runtime application may be updated based upon the updated assembly. For example, prebuilt components modified by modification gestures may be torn down, updated with a corresponding update assembly, and reloaded into the runtime application, while the runtime application is in a runtime state.

### BACKGROUND

Current development paradigms for developing data applications may involve a cycle of writing code, building, running, and testing the data application. The cycle may be iterative because when the code is modified or new code is added, the data application is rebuilt, redeployed, and re-executed, otherwise the effects of adding or modifying the code may not be evident. To facilitate this cycle, data application may be designed within interactive development environment and are separately executed within runtime environments. To modify the data application, the data application is torn down, the developer redesigns the code within the design environment, and then the data application is re-executed. Because the design environment and the runtime environment are separated, the developer is unable to view the running application while redesigning the data application, thus the developer may have to spend additional time because of a loss in context and/or context switching.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for developing an application at runtime is disclosed herein. An application is presented to a developer in a runtime state. The runtime application may comprise prebuilt components (e.g., components) that the user may use to reconstruct the application while in execution mode. During development, the runtime application may be placed in execution mode. When in execution mode at design time, the runtime application may receive modification gestures from a user corresponding to modifications made to the runtime application and/or components within the runtime application. A modification gesture may comprise adding an object (e.g., a textbox) to a form on the runtime application or an alteration of the position of an object on the form. A modification gesture may comprise a rude edit. The rude edit may change the entire model (e.g., data store changes, data model changes, etc.), thus a tear down and rebuild of the entire application may occur. This allows the user to design and modify the runtime application in design mode while the runtime application is in a runtime state (e.g., executing as a process). This will further allow for the same tools the developer uses to be exposed to end users in the future.

Upon receiving a modification gesture, an update assembly may or may not be built corresponding to the modifications made to the runtime application. If a new assembly is desirable (e.g., the developer wrote new code), then the update assembly may comprise recompiled code and/or deltas (e.g., code change deltas) corresponding to the modifications. A metadata describing the running application may be updated based upon the modifications. The updated application metadata may be associated with the update assembly. Once the update assembly is created, a determination is made as to whether at least one component within the runtime application can be updated without a restart. If at least one component can be updated without a restart, then the at least one component is updated with the update assembly. For example, a component may be torn down while the runtime application is in a runtime state. The component is updated with the update assembly and may be recompiled. The updated component may then be reloaded into the runtime application while the runtime is in the runtime state.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of developing an application at runtime.

FIG. 2 is a component block diagram illustrating an exemplary system for developing an application at runtime.

FIG. 3 is an illustration of an example of a runtime application executing in a design mode within a runtime environment.

FIG. 4 is an illustration of an example of developing an application at runtime through modification gestures while in a design mode.

FIG. 5 is an illustration of an example of developing an application at runtime through modification gestures while in a design mode.

FIG. 6 is an illustration of an exemplary computer-readable medium whereon processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Data applications are commonly developed within an integrated development environment. The integrated development environment (IDE) may comprise a source code editor, a compiler, a build tool, a debugger, and/or other tools used in creating a data application. In developing an application, a developer may write source code within the IDE. A compile and/or build operation may be performed on the source code to produce an output (e.g., a binary executable). The output may be executed as a runtime data application, in which the developer may be able to test and debug. This development cycle may become iterative because if the developer modifies the source code after the output has executed, then the runtime data application is torn down so that the source code may be rewritten within the IDE. Once the source code is rewritten, the cycle of rebuilding, redeploying and re-executing may reiterate.

In one example, a developer may use an IDE to create a calculator application. The developer may create a form representing a calculator. The developer may write source code to perform calculator functionality associated with the form. The developer may write the source code in a high-level programming language. A compile and/or build may be performed on the source code to create an output (e.g., a binary executable). The output may be executed as a runtime calculator, in which the developer may be able to test the calculator application. If the developer decides to create new source code and/or rewrite the existing source code (e.g., an error occurs within the source code that may be modified to fix the error, a new button with corresponding source code functionality may be added, etc.), then the runtime calculator is torn down from a runtime state (e.g., the calculator is not executing).

To add and/or modify the source code, the developer may return to the IDE to view and rewrite the source code. Once the source code is modified, the developer may recompile and/or rebuild the modified source code, which may then be executed; otherwise the modifications may not be evident. The iterative cycle of developing a data application may be time consuming and changes may not be evident until the data application is rebuilt, redeployed, and re-executed. The developer is limited to modifying the data application when the data application is not in a runtime state. A design time environment used to design the data application and a runtime environment used to execute the runtime application may be exclusive of one another (e.g., a design experience may not be available for a runtime application while executing within a runtime environment).

As set forth herein, a technique for developing an application at runtime is provided. A design experience is provided for a runtime application in a runtime state (e.g., executing). At runtime, the runtime application may be put into a design mode. While in design mode, a modification gesture may be performed on the runtime application. The modification gesture may comprise adding an object, removing an object, reconfiguring an object, replacing an object, modifying source code associated with an object, and/or other modifications that may be performed on a runtime application. When the runtime application is in design mode, the developer may modify the runtime through modification gestures, while the runtime application is executing in the runtime state (e.g., the modification gestures may be performed on the runtime application while the runtime application is running).

The runtime application may comprise prebuilt components which may be configurable through modification gestures. Prebuilt components and modification gestures associated with prebuilt components may be built into the runtime application during the development of the runtime application (e.g., when a compile and/or build occurs within design time environment). While in design mode, a developer may be able to select and perform modification gestures on the runtime application and/or prebuilt components. For example, a developer may alter an event handler associated with an object. In another example, a developer may alter the position of the object on a form. A prebuilt component may be associated with the object, which may be torn down, rebuilt, and reloaded without taking the runtime application out of the runtime state. A similar model may be used for design time modifications as the runtime components. The design time components may be removed as the application is deployed.

While the runtime application is in design mode at runtime, modification gestures may be listened for within a runtime environment (e.g., an execution environment hosting the runtime application). For example, an active editor associated with the runtime application may listen for modification gestures. Upon determining a modification gesture is invoked, the modification gesture and/or modifications associated with the modification gesture may be sent to a design time environment to handle. Application metadata associated with the runtime application may be altered based upon the modifications made to the runtime application (e.g., a metadata build update component performs an update on the application metadata). A build pipeline component may use the modifications and/or altered application metadata to create an updated assembly which may comprise at least one delta that may be used to update the runtime application and/or corresponding prebuilt components.

Communication between the runtime environment and the design time environment may be handled by a communication protocol component. A design time update component may send the update assembly to a runtime update component. The runtime update component may determine whether at least one component within the runtime application may be updated with the update assembly without a restart. If a component may be updated without a restart, then the update assembly and/or deltas within the update assembly may be used to update the component within the runtime application. In one example, the runtime update component may tear down a component, while the runtime application is in a runtime state. The torn down component is updated with the update assembly. The updated component may be associated and/or reloaded into the runtime application while the runtime application is in a runtime state.

Providing a design experience while a runtime application is in a runtime state allows the developer and/or the end user to directly make modifications to the runtime application without tearing down the runtime, rewriting source code, rebuilding the source code, and re-executing the runtime application. Instead, modifications are received as modification gestures, the modifications are built into an update assembly within a design time environment, and then the update assembly is associated with the runtime application without the runtime application being torn down.

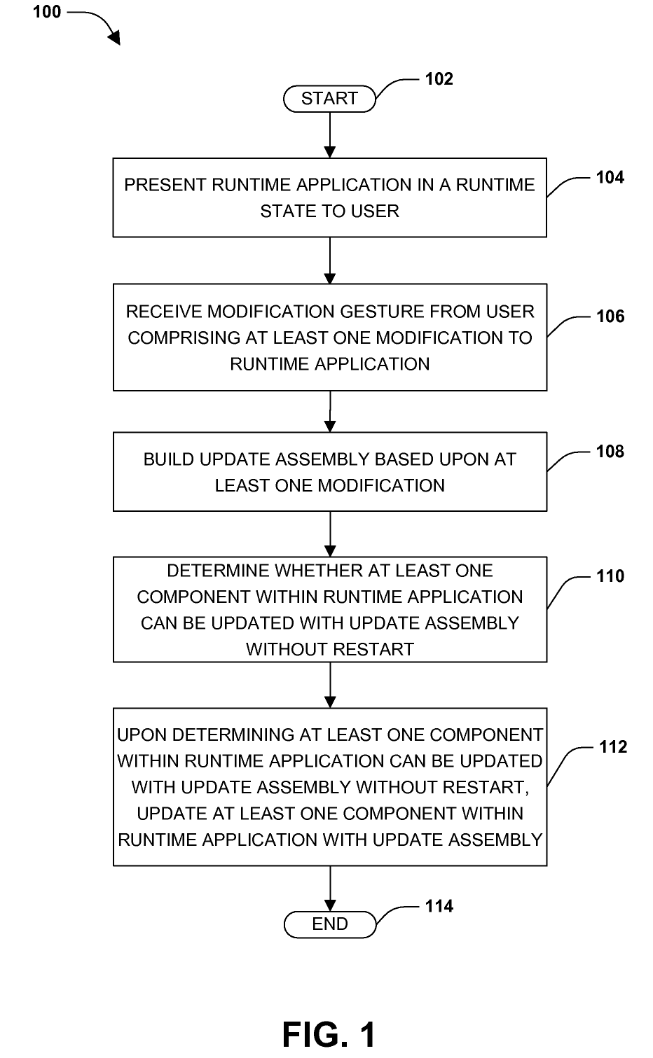

One embodiment of developing an application at runtime is illustrated by an exemplary method 100 in FIG. 1. At 102, the method begins. At 104, a runtime application is presented in a runtime state to a user. For example, source code developed within an IDE may be compiled and built into an output (e.g., binary executable). The output may be executed within a runtime environment (e.g., an operating system) as a runtime application that is presented to the user.

At 106, a modification gesture comprising at least one modification to the runtime application is received from the user. The runtime application may be within a design mode, wherein the user may modify the runtime application through modification gestures. The runtime application may switch into the design mode based upon a request from the user, wherein modification gestures may be listened for. A modification gesture may comprise adding an object, removing an object, reconfiguring an object, adding source code, removing source code, altering the appearance of the form, and/or other modifications that may be made to the runtime application's appearance and/or underlying source code. A modification gesture may be performed within the runtime application.

An update service, within the runtime environment, may listen for modification gestures through the runtime application. The modifications within the modification gestures may be locally saved and compared with an application metadata describing the runtime application. By comparing the modifications, at least one delta may be created describing the modifications, which may be code change deltas if the modification pertained to the source code or form change deltas if the modification pertained to the appearance of the form. The application metadata may be updated based upon the deltas.

At 108, an update assembly is built based upon at least one modification corresponding to the modification gestures. The update assembly may comprise source code, corresponding to the modifications, which may be applied as an update to components within the runtime application. The source code may be used to rebuild existing components and/or create new components within the runtime application without tearing down the runtime application (e.g., only affected components are torn down). The update assembly may comprise deltas (e.g., source code deltas, form change deltas) which may be used to update the runtime application and/or components within the runtime application. The update assembly may be associated with the application metadata corresponding to the modifications. The update assembly may be created within a design time environment by a build pipeline component. The update assembly may be communicated through a communication protocol component to a runtime update component within the runtime environment.

At 110, a determination is made as to whether at least one component within the runtime application can be updated with the update assembly without a restart. The runtime application may be prebuilt with components. The components may be redesigned, added, and/or removed through modification gestures within the runtime application. A component may represent source code previously injected into the runtime application within the design time environment (e.g., when the source code is built and/or compiled into an output). The components may be configured to be torn down and rebuilt using the update assembly while the runtime application is in a runtime state (e.g., the runtime application is executing while modifications and/or updates are made to the runtime application). This allows a user to continue interacting with the runtime application while an update is occurring. The components which are designable act similar to standard runtime components, other than that they may be removed, updated, and rebuilt during runtime.

If the components within the runtime application cannot be updated without a restart, then the runtime application may be torn down from the runtime state. A new runtime application is built based upon the modifications. The new runtime application may be presented to the user in a runtime state.

At 112, upon determining at least one component within the runtime application can be updated without a restart, at least one component within the runtime application is updated with the update assembly. This allows the runtime application to be modified and updated on a component by component basis, thereby allowing the runtime application to be modified in a runtime state. The update assembly may be associated with components that are to be updated. The components may be torn down from the runtime application. The torn down components may be updated using the update assembly. For example, the update assembly may comprise source code and/or deltas that may be used to recompile, rebuild, and/or replace the torn down components. The updated component may be reloaded into the runtime application while the runtime application is in the runtime state.

In one example, a modification gesture may be received by a user modifying a button object within a runtime application. The button object may be associated with a button component that may be updated based upon the modification. Upon receiving the modification gesture, an update assembly may be built comprising source code used to update the button component. A determination is made as to whether the button component may be updated with the update assembly without a restart. If the button component may be updated without a restart, then the button component may be torn down. The torn down button component may be updated with the update assembly (e.g., source code within the update assembly may be used to recompile, rebuild, and/or replace the button component). The updated button component may be reloaded into the runtime application while the runtime application is in the runtime state. At 114, the method ends.

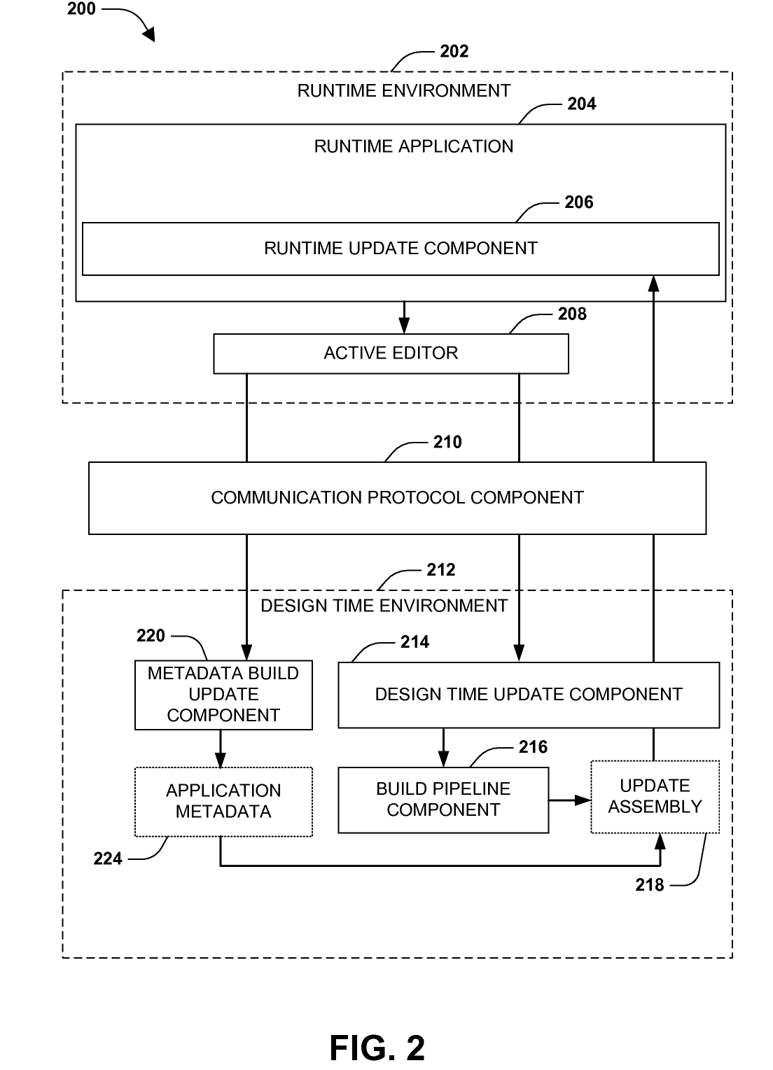

FIG. 2 illustrates an example of a system 200 configured to develop an application at runtime. The system 200 may comprise a runtime environment 202 and a design time environment 212. The design time environment 212 may be an environment used to facilitate the writing, building, compiling, and/or initiating an execution of source code associated with the runtime application 204. The runtime environment 202 may be an environment in which the runtime application 204 may execute within. A communication protocol component 210 may be configured to manage communication between the runtime environment (e.g., messages from an active editor 208 comprising modifications) and the design time environment (e.g., messages from a design time update component 214 comprising an update assembly).

The runtime environment 202 may comprise the runtime application 204 and the active editor 208 associated with the runtime application 204. The runtime application 204 may be configured to execute within a runtime state. While in the runtime state (e.g., the runtime application 204 is executing), the runtime application 204 may be in a design mode or an execution mode based upon a request from a user. While in design mode, modification gestures may be made upon the runtime application 204 and handled by the active editor 208. While in execution mode, modification gestures may not be available and/or handled.

The active editor 208 may be configured to listen for and receive modification gestures occurring within the runtime application 204. The modification gestures may comprise at least one modification to the runtime application 204 (e.g., a change in source code, a change in form appearance). For example, the modification gesture may comprise an add component gesture, a remove component gesture, a reconfigure component gesture, and/or a replace component gesture. The modification gestures may be associated with components prebuilt into the runtime application 204. The prebuilt components may be redesigned by a user based upon modification gestures. The active editor 208 may be configured to send at least one modification to the design time update component 214 within the design time environment 212.

The runtime application 204 may comprise the runtime update component 206 configured to receive an update assembly 218 from the design time update component 214. The runtime update component 206 may determine whether the update assembly 218 can be applied to the runtime application 204 (e.g., update modified components within the runtime application 204) without a restart. If the update assembly can be applied without a restart, then the runtime update component 206 may instruct at least one component (e.g., a component in which a modification gestures was performed on) within the runtime application 204 to perform an update based upon the update assembly 218. For example, the update assembly 218 may comprise information (e.g., source code, deltas, code deltas, form deltas, metadata, etc.) used to rebuild a component within the runtime application 204. The runtime update component 206 may instruct the component to update based upon the information within the update assembly 218. The component may be torn down while the runtime application 204 is within the runtime state. The torn down component may be updated (e.g., recompiled, rebuilt, and/or replaced) with the information in the update assembly 218. The updated component may be reloaded into the runtime application 204.

The design time environment may comprise the design time update component 214, a build pipeline component 216, and/or a metadata build update component 220. The metadata build component 220 may be configured to receive modification data from the active editor 208. The metadata build component 220 may be configured to update an application metadata 224, describing the runtime application 204, based upon the modification data. Once updated, the application metadata 224 may be associated with the update assembly 218.

The design time update component 214 may be configured to receive at least one modification from the active editor 208. The design time update component may request the build pipeline component 216 to create an update assembly based upon the at least one modification and/or associated application metadata 224. The build pipeline component 216 may be configured to create the update assembly 218 based upon the modifications and/or application metadata 224. The build pipeline component 216 may create at least one delta within the update assembly. The delta may be a code change delta based upon modifications made to user code within the runtime application 204 or a form change delta based upon modifications made to a form's appearance within the runtime application 204. The build pipeline component 216 may create the update assembly based upon deltas, code change deltas, form change deltas, source code, and/or other information corresponding with the modifications and/or the runtime application 204. The design time update component 214 may be configured to send the update assembly 218 to the runtime update component 206.

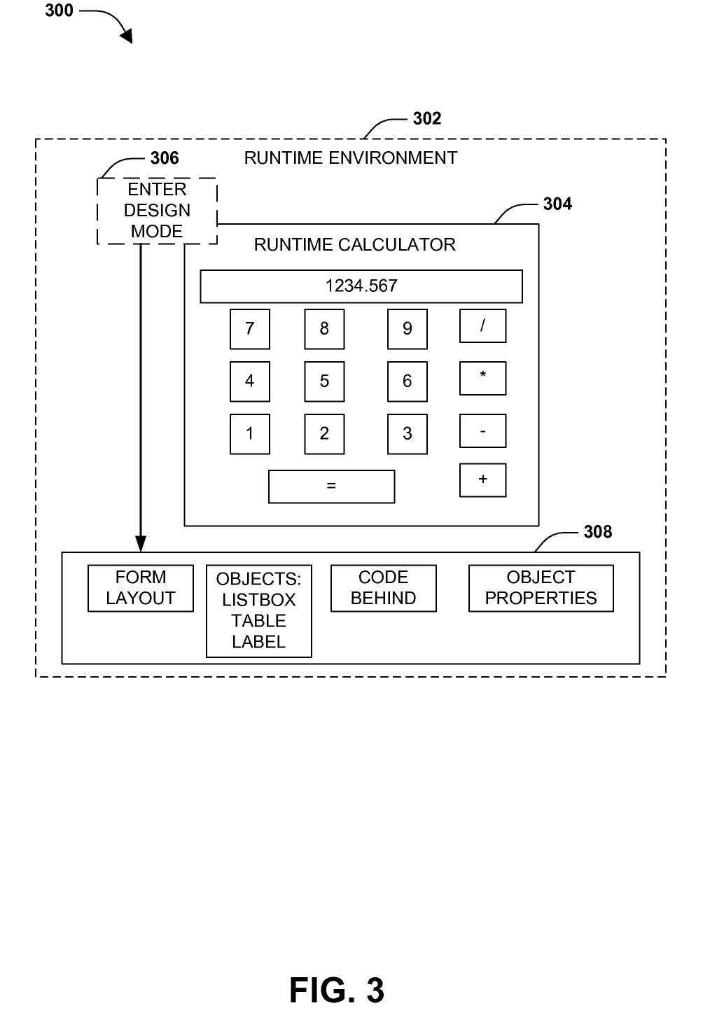

FIG. 3 illustrates an example 300 of a runtime application executing in a design mode within a runtime environment 302. The runtime environment 302 comprises a runtime calculator 304. The runtime calculator 304 may be in a runtime state, wherein the functionality of the runtime calculator 304 is operable (e.g., buttons, labels, and operations are functioning). While in the runtime state, the runtime calculator may execute in a design mode or an execution mode. While in the execution mode, the runtime calculator's 304 functionality is operable, but the runtime calculator 304 is not modifiable. While in the design more, the runtime calculator's 304 functionality is operable and the runtime calculator is modifiable.

The runtime calculator 304 may comprise components associated with the visual aspects of the runtime calculator 304 (e.g., a form) and the functional aspects of the runtime calculator 304 (e.g., compiled source code). The components may be configurable within the runtime calculator 304 while in the design mode. The enter design mode button 306 may allow a user to request the runtime calculator 304 to enter the design mode.

Once in the design mode, the runtime calculator 304 continues to provide runtime functionality (e.g., a user may invoke a calculation functionality), but also accepts modification gestures from a user. In one example, a component toolbox 308 may be presented to the user. A modification gesture may be performed by removing a component from the runtime calculator 304, modifying a component within the runtime calculator 304, and/or adding a new component from the component toolbox 308 to the runtime calculator 304. The components may be prebuilt into the runtime calculator 304 when the runtime calculator 304 was complied and/or built.

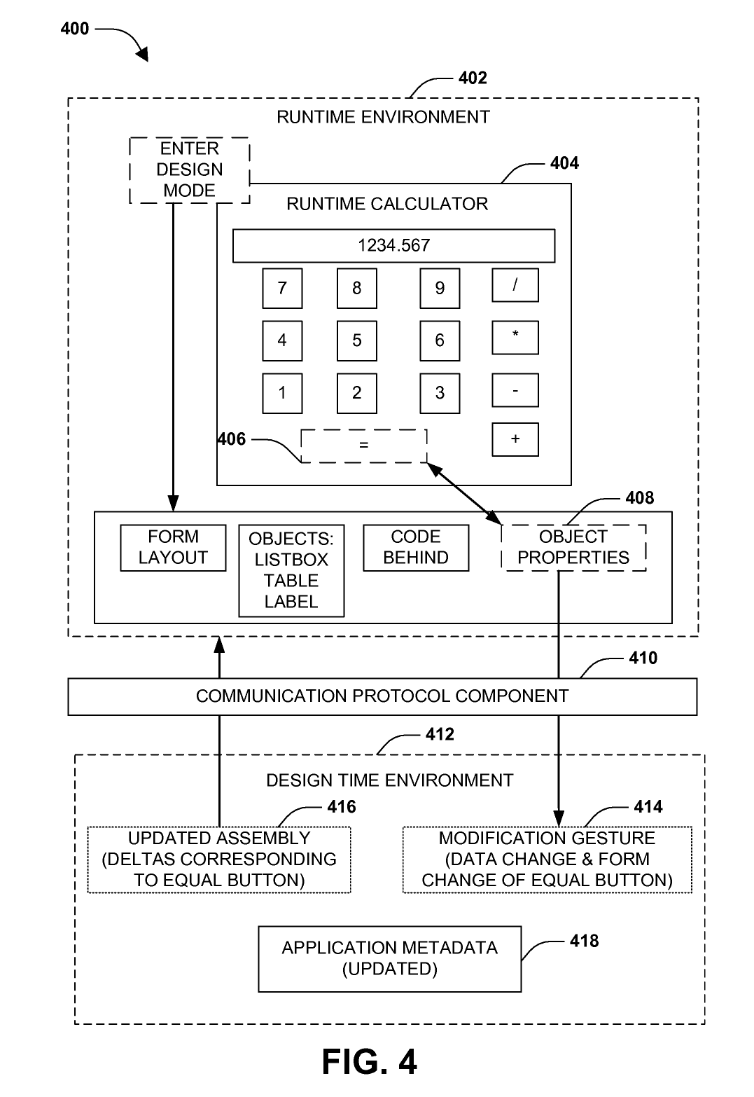

FIG. 4 illustrates an example 400 of developing a runtime application through modification gestures while in a design mode. A runtime environment 402 may comprise a runtime calculator 404 presented in a runtime state to a user. The runtime calculator 404 may enter a design mode based upon a request from the user. Once in the design mode, modification gestures may be performed on the runtime calculator 404. For example, the runtime calculator 404 may comprise an equal button component associated with an equal button 406 on the runtime calculator 404. The user may invoke an object properties modification gesture 408 to modify the equal button 406 (e.g., the user may change the color of the equal button 406 and an event handler of the equal button 406). The modifications associated with the modification gesture may be received by an active editor. The active editor may send the modifications through a communication protocol component 410 to a design time environment 412. Within the design time environment 412, the modification gestures 414 (e.g., modifications corresponding to the modification gestures) may be used to build an updated assembly 416.

Once the modification gestures 414 are received within the design time environment 412, an application metadata 418 may be updated based upon the modification gestures 414 (e.g., modifications made to the runtime calculator 404). The update assembly 416 may be created based upon a code change delta (e.g., modification of the user code of the equal button 406) and a form change delta (e.g., modification of the color of the equal button 406). The update assembly 416 may be sent through the communication protocol component 410 to the runtime environment 402. A runtime update component associated with the runtime calculator may be configured to receive the update assembly 416 and determine whether the equal button component corresponding to the equal button 406 may be updated without a restart of the runtime calculator 404.

If the equal button component can be updated without a restart, then the update assembly 416 is used to update the equal button component. The equal button component may be torn down, updated, and reloaded into the runtime calculator 404. Once the equal button component is reloaded, the equal button 406 will reflect the modifications of the user code and the color change. During the modification and update, the runtime calculator 404 is in a runtime state, wherein the runtime calculator 404 is executing and operable.

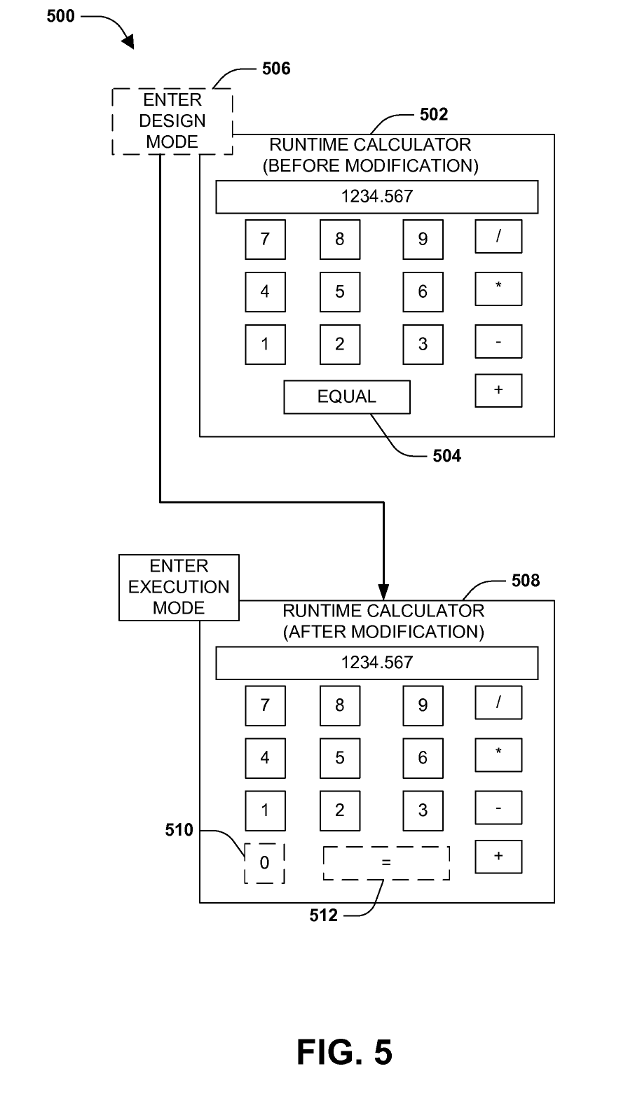

FIG. 5 illustrates an example 500 of developing a runtime application through modification gestures while in a design mode. A runtime calculator 502 (before modifications) may be presented to a user in a runtime state. The runtime calculator 502 may comprise prebuilt components corresponding to objects, functionality, and/or other parts of the runtime calculator 502 (e.g., an equal button component corresponding to the appearance and functionality of the equal button 504). The prebuilt components may be created and incorporated into the runtime calculator 502 during an initial compile and/or build. The prebuilt components may be modifiable by the user while the runtime calculator 502 is in a design mode (e.g., modifiable through modification gestures).

In one example, the user may invoke an enter design mode button 506 to switch the runtime calculator 502 into a design mode while in the runtime state. Once the runtime calculator 502 is in the runtime state, the user may perform modification gestures on the runtime calculator 502 and/or prebuilt components. For example, the user may alter the position of the equal button 504 and add a zero button to the runtime calculator 502. Upon receiving the modification gestures, a first form change delta may be created corresponding to the modification gesture to alter the equal button's text and position on the form. A second form change delta may be created corresponding to the addition modification gesture for the zero button. A code change delta may be created corresponding to user created source code for the zero button. An application metadata describing the runtime calculator 502 may be changed based upon the deltas.

An update assembly may be created comprising the first form change delta, the second form change delta, the code change delta, and/or additional metadata or source code. The runtime calculator 502 may be updated with the update assembly, wherein a runtime calculator 508 (after modification) reflects the modifications made by the user. The update may consist of tearing down, rebuilding, and reloading prebuilt components (e.g., a prebuilt component corresponding to the equal button 504; creating a zero button component). The runtime calculator 508 now comprises a zero button 510 and an equal button 512 after the modifications. During the presentation, modification, and update of the runtime calculator 502, the runtime calculator 502 is in a runtime state, thus allowing the user to modify the runtime calculator 502 without tearing down the runtime calculator 502, modifying source code, rebuilding/recompiling the source code, and reexecuting the runtime calculator 502.

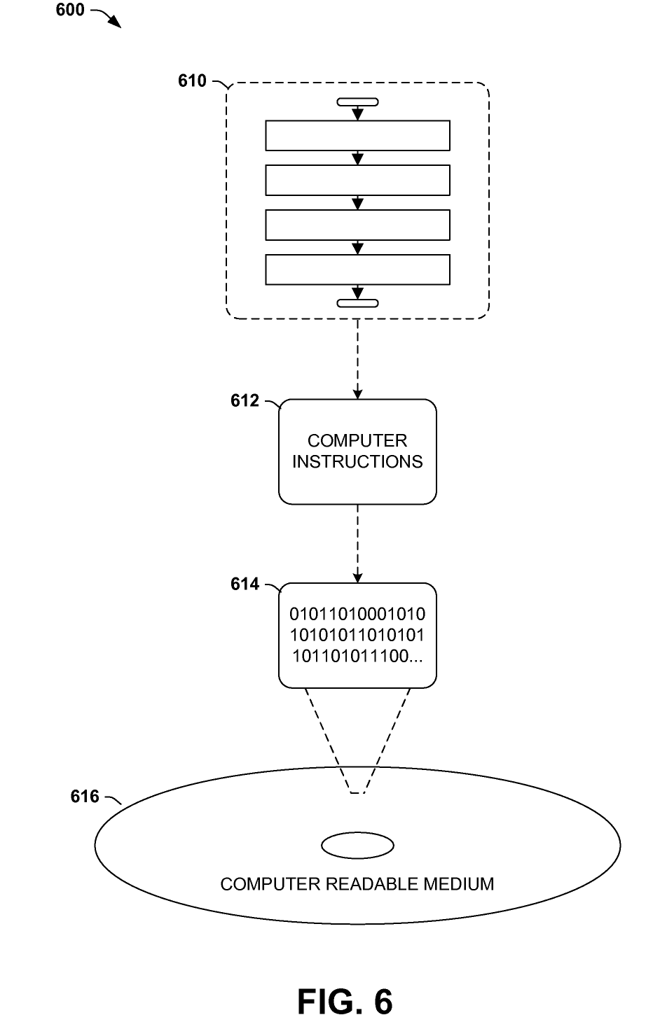

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, or a platter of a hard disk drive), on which is encoded computer-readable data 610. This computer-readable data 610 in turn comprises a set of computer instructions 612 configured to operate according to one or more of the principles set forth herein. In one such embodiment 600, the processor-executable instructions 614 may be configured to perform a method, such as the exemplary method 100 of FIG. 1, for example. In another such embodiment, the processor-executable instructions 614 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

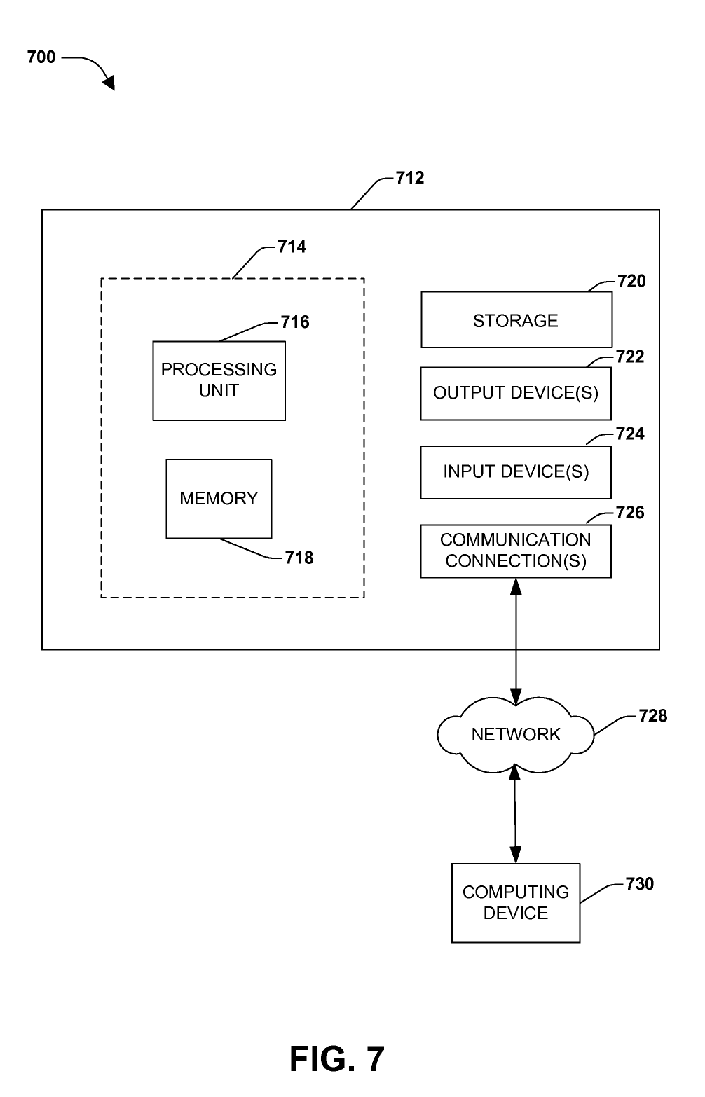

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for developing an application at runtime comprising:
presenting a runtime application in a runtime state to a user;
receiving a modification gesture from the user comprising at least one modification to the runtime application;
building an update assembly based upon the at least one modification;
determining whether at least one component within the runtime application can be updated with the update assembly without a restart; and
upon determining at least one component within the runtime application can be updated with the update assembly without a restart, updating the at least one component within the runtime application with the update assembly.

2. The method of claim 1, comprising:
upon determining at least one component within the runtime application cannot be updated with the update assembly without a restart:
tearing down the runtime application from the runtime state;
building a new runtime application comprising the at least one modification; and
presenting the new runtime application to a user in a runtime state.

3. The method of claim 1, the runtime application comprising at least one component configured to receive a modification gesture from a user regarding a modification to the component.

4. The method of claim 3, the modification gesture comprising at least one of:
an add component gesture;
a remove component gesture;
a reconfigure component gesture; and
a replace component gesture.

5. The method of claim 1, the building an update assembly comprising at least one of the following:
designating a modification as a code change delta based upon the modification corresponding to a change in user code of the runtime application; and
designating a modification as a form change delta based upon the modification corresponding to a change in form appearance of the runtime application.

6. The method of claim 5, the building an update assembly comprising at least one of the following:
associating a delta corresponding to a modification with the update assembly;
associating a code change delta with the update assembly; and
associating a form change delta with the update assembly.

7. The method of claim 6, the building an update assembly comprising:
updating an application metadata describing the running application; and
associating the application metadata with the update assembly.

8. The method of claim 1, comprising:
tearing down at least one component within the runtime application, while in the runtime state;
updating the at least one torn down component with the update assembly, while in the runtime state; and
reloading at least one updated component, while in the runtime state.

9. The method of claim 1, comprising:
receiving a request to switch the runtime application to a design mode;
switching the runtime application into the design mode while in the runtime state; and
listening for at least one modification gesture from the user comprising at least one modification to the runtime application.

10. A system for developing an application at runtime comprising:
a runtime environment comprising:
a runtime application in a runtime state;
an active editor component configured to:
receive a modification gesture comprising at least one modification upon the runtime application from a user; and
send the at least one modification to a design time update component;
a runtime update component configured to:
receive an update assembly from the design time update component;
determine whether the update assembly can be applied to the runtime application without a restart; and
instruct at least one component within the runtime application to perform an update based upon the update assembly; and
a design time environment comprising:
the design time update component configured to:
receive at least one modification from the active editor;
request a build pipeline component to create an update assembly based upon the at least one modification; and
send the update assembly to the runtime update component; and
the build pipeline component configured to:
create an update assembly based upon at least one modification.

11. The system of claim 10, the runtime application configured to:
execute within a design mode while in the runtime state; and
execute within an execution mode while in the runtime state.

12. The system of claim 11, while the runtime application is in the design mode, the active editor configured to listen for at least one modification gesture comprising at least one of:
an add component gesture;
a remove component gesture;
a reconfigure component gesture; and
a replace component gesture.

13. The system of claim 10, the build pipeline component configured to create at least one delta within the update assembly.

14. The system of claim 13, the build pipeline component configured to:
create a code change delta based upon a modification corresponding to a change in user code of the runtime application; and
create a form change delta based upon a modification corresponding to a change in form appearance of the runtime application.

15. The system of claim 14, the build pipeline component configured to create the update assembly based upon at least one of:
a set of source code data;
a delta corresponding to a modification;
a code change delta; and
a form change delta.

16. The system of claim 10, comprising:
a metadata build update component configured to update an application metadata, describing the runtime application, based upon at least one modification.

17. The system of claim 10, the design time update component configured to perform a global commit.

18. The system of claim 10, comprising:
a communication protocol component configured to manage communication between the runtime space and the design time space.

19. The system of claim 10, the runtime update component configured to:
tear down a component within the runtime application, while the runtime application is in the runtime state;
update the torn down component with the update assembly, while the runtime application is in the runtime state; and
reload the updated component, while the runtime application is in the runtime state.

20. A method for developing an application at runtime comprising:
presenting a runtime application comprising prebuilt components in a runtime state to a user;
receiving a modification gesture modifying at least one prebuilt component from the user;
building an update assembly based upon the modification gesture, the update assembly comprising at least one of:
a set of source code data corresponding to at least one prebuilt component that was modified; and
at least one delta corresponding to at least one prebuilt component that was modified;
determining whether at least one modified prebuilt component within the runtime application can be updated with the update assembly without a restart; and
upon determining at least one modified prebuilt component within the runtime application can be updated with the update assembly without a restart, updating the at least one modified prebuilt component within the runtime application with the update assembly comprising:
tearing down at least one modified prebuilt component within the runtime application, while in the runtime state;
updating the at least one torn down prebuilt component with the update assembly, while in the runtime state; and
reloading at least one updated prebuilt component, while in the runtime state.
